(19) United States
(12) Patent Application Publication
(10) Pub. No.: US 2021/0285308 A1
(43) Pub. Date: Sep. 16, 2021

(54) USE OF ULTRA LIGHTWEIGHT PARTICULATES IN MULTI-PATH GRAVEL PACKING OPERATIONS

(71) Applicant: Baker Hughes Holdings LLC, Houston, TX (US)

(72) Inventors: Christophe A. Malbrel, Houston, TX (US); James B. Crews, Willis, TX (US)

(73) Assignee: Baker Hughes Holdings LLC

(21) Appl. No.: 17/315,138

(22) Filed: May 7, 2021

Related U.S. Application Data
(63) Continuation of application No. 15/761,996, filed on Mar. 21, 2018.
(60) Provisional application No. 61/987,957, filed on May 2, 2014.

(51) Int. Cl. E21B 43/04; E21B 43/08; C09K 8/504; C09K 8/508

(52) U.S. Cl. CPC E21B 43/045; E21B 43/08; E21B 43/04; C09K 2208/04; C09K 8/5083; C09K 8/5086; C09K 8/5045

(57) ABSTRACT

A well penetrating a subterranean formation may be subjected to a multi-path gravel packing operation by using a fluid containing an ultra lightweight particulate having an apparent specific gravity less than or equal to 2.45 which is substantially neutrally buoyant in a carrier fluid. The fluid is flowed through one or more transport tubes which, with a gravel packing screen, constitute a screen assembly. A gravel pack is formed onto the screen of the screen assembly in-situ.

This application claims the benefit of U.S. non-provisional patent application Ser. No. 15/761,996 filed on Mar. 21, 2018, which claims the benefit of § 371 application PCT/US2015/029074 filed on May 4, 2015, which claims the benefit of U.S. provisional patent application 61/987,957 filed on May 2, 2014.

### FIELD OF THE DISCLOSURE

Ultra lightweight particulates having an apparent specific gravity less than or equal to 2.45 improve efficiency of gravel pack operations which employ screens having alternate flow paths.

### BACKGROUND OF THE DISCLOSURE

The production of hydrocarbons from unconsolidated or poorly consolidated formations penetrated by a well may result in the production of sand along with hydrocarbons. Produced sand is abrasive to tubing, pumps and valves within the well. In addition, it often partially or completely clogs the well, thereby making necessary an expensive workover. In addition to having to be removed from produced fluids at the surface, sand flowing from the formation often results in collapse of the formation and, when present, casing within the wellbore.

A technique commonly employed for mitigating the flow of sand from an unconsolidated or poorly consolidated formation consists of generating a gravel pack in the well adjacent to the formation. In a typical gravel pack completion, a screen is lowered into the wellbore on a workstring and is positioned adjacent the subterranean formation to be completed. Particulate material, collectively referred to as “gravel” or proppant, and a carrier fluid is then pumped as a slurry down the workstring and exits into the well annulus formed between the screen and well casing or, when the sand control operation is open hole, between the screen and open hole. The carrier liquid in the slurry normally flows into the formation and/or through the screen, itself, which, in turn, is sized to prevent flow of gravel. This results in the gravel being deposited or “screened out” in the well annulus where it collects to form a gravel pack around the screen. The gravel, in turn, is sized so that it forms a permeable mass which allows flow of the produced fluids through and into the screen while blocking the flow of sand produced with the production fluids.

One of the major problems associated with gravel packing, especially in gravel packing long or inclined intervals, is the development of obstructions in the wellbore. These obstructions caused by formation collapse or gravel build-up in the annulus prevent the slurry to be fully circulated and leave a bare screen beyond the obstruction.

More consistent sand control has been achieved by the use of “alternate path” or “multi-path” well screens which provide good distribution of gravel throughout the entire completion interval even when sand bridges form. Exemplary screens are disclosed in U.S. Pat. Nos. 4,945,991; 5,082,052; 5,113,935; 5,417,284; and 5,419,394 wherein individual shunts or transport tubes are placed onto the outer surface of the screen. Alternative designs have been disclosed wherein transport tubes are placed inside the screen in order to minimize damage to the transport tubes during assembly and during installation. See, for instance, U.S. Pat. Nos. 5,341,880, 5,476,143, and 5,515,915. In U.S. Pat. Nos. 5,868,200 and 6,227,303, concentrically mounted perforated, protective shrouds are placed over the screens and the transport tubes in order protect the transport tubes.

In these well screens, the multi-paths (e.g. transport tubes with exit ports or by-pass conduits) extend along the length of the screen and are in fluid communication with the gravel slurry as the slurry enters the well annulus around the screen. If a sand bridge forms in the annulus, the slurry is still free to flow through the conduits and out into the annulus through the exit ports in the transport tubes to complete the filling of the annulus above and/or below the sand bridge. Alternative path screens are used in gravel packing operations having a casing placed within the wellbore as well as in open hole gravel packing.

In practice, the carrier fluid used to transport the gravel particulates through the transport tubes is a viscous gel. Such gels are typically viscoelastic surfactant or linear gels such as xanthan or hydroxyethylcellulose based fluids. The preparation of such fluids is relatively complex since they typically require breakers, buffers, biocides, etc. Compatibility issues with some crudes are also known to exist. For instance, emulsions may be created between reservoir hydrocarbons and fluids containing viscoelastic surfactants while xanthan based fluids are often hard to break, leading to formation damage and permeability impairment. Further, after-pack settling occurs with such gels. Gravel packs are thus unevenly distributed with void spaces along the screen.

It should be understood that the above-described discussion is provided for illustrative purposes only and is not intended to limit the scope or subject matter of the appended claims or those of any related patent application or patent. Thus, none of the appended claims or claims of any related application or patent should be limited by the above discussion or construed to address, include or exclude each or any of the above-cited features or disadvantages merely because of the mention thereof herein.

Accordingly, there exists a need for improved methods for gravel pack operations employing multi-path screens having one or more of the attributes or capabilities described or shown in, or as may be apparent from, the other portions of this patent.

### SUMMARY OF THE DISCLOSURE

In an embodiment of the disclosure, a method of gravel packing a well is provided. In the method, a screen assembly having a screen and at least one transport tube having exit ports is placed within the well wherein the at least one transport tube extends along the length of the screen. A well treatment fluid is then pumped into the well. The well treatment fluid contains a carrier fluid and ultra lightweight (ULW) particulates having an apparent specific gravity (ASG) (API RP 60) less than or equal to 2.45. If an obstruction is present in the wellbore, for example when formation collapses in the annulus, the carrier fluid flows through the transport tubes down beyond the obstruction and exits through the exit ports. As a result, a gravel pack is formed onto the screen of the screen assembly in-situ by the ULW particulates.

In another embodiment, a method of completing a well by horizontal openhole gravel packing is provided. In this method, a sand screen assembly is placed inside the well and an annulus is formed between the sand screen assembly and the subterranean formation. The sand screen assembly contains a screen and at least one transport tube having at least one exit port. The transport tube(s) extends down the length of the screen. A well treatment fluid is pumped into the well. The well treatment fluid comprises a carrier fluid and ultra lightweight particulates having an ASG less than or equal to 2.45. The well treatment fluid is allowed to flow through one or more exit ports in one or more of the transport tubes. A gravel pack is formed from the ULW particulates onto the screen of the sand screen assembly.

In another embodiment, a method of gravel packing a well is provided wherein a series of connecting screen assemblies are positioned inside the well. Each screen assembly has a screen and at least one transport tube having one or more exit ports. A well treatment fluid is pumped into the well. The well treatment fluid comprises a carrier fluid and ultra lightweight particulates having an ASG less than or equal to 2.45. The ultra lightweight particulates are substantially neutrally buoyant in the carrier fluid. The ULW particulates form a gravel pack onto the screen of the screen assembly.

In a further embodiment, a method of gravel packing an open hole well penetrating a subterranean formation is provided. In this method, a screen assembly is positioned inside the open hole well. The screen assembly contains a screen and at least one transport tube having one or more exit ports. A well treatment fluid is pumped into the well. The well treatment fluid comprises a carrier fluid, a friction reducer and ultra lightweight particulates. The ultra lightweight particulates have an ASG less than or equal to 2.45. The ultra lightweight particulates are substantially neutrally buoyant in the carrier fluid. A gravel pack is formed onto the screen of the screen assembly from the ULW particulates.

In another embodiment of the disclosure, a method of gravel packing an open hole well penetrating a subterranean formation is provided. In this method, a screen assembly is positioned inside the open hole well. The screen assembly comprises a screen and at least one transport tube having one or more exit ports. The transport tube(s) are located inside of the screen. A well treatment fluid is pumped into the well. The well treatment fluid comprises a carrier and ultra lightweight particulates having an ASG less than or equal to 2.45. The ultra lightweight particulates are substantially neutrally buoyant in the carrier. The well treatment fluid is flowed through at least one of the transport tube(s) and a gravel pack is formed from the ULW particulates onto the screen of the screen assembly.

In another embodiment of the disclosure, a method of gravel packing a well is provided wherein a casing is first positioned within the well. The casing is then perforated to provide flow of the well treatment fluid into the subterranean formation penetrated by the well. A screen assembly is then positioned inside the well between the casing and the annulus of the well. The screen assembly comprises a screen and at least one transport tube having one or more exit ports. The at least one transport tube may be positioned within the screen. A well treatment fluid is then pumped into the well and through the perforations in the casing. The well treatment fluid may comprise a carrier and ultra lightweight particulates having an ASG less than or equal to 2.45, wherein the ultra lightweight particulates are substantially neutrally buoyant in the carrier. The well treatment fluid is allowed to flow through the screen assembly and exit through one or more of the exit ports. A gravel pack may then be formed from the ULW particulates onto the screen of the screen assembly.

Accordingly, the present disclosure includes features and advantages which are believed to enhance multi-path gravel pack operations. Characteristics and advantages of the present disclosure described above and additional features and benefits will be readily apparent to those skilled in the art upon consideration of the following detailed description of various embodiments and referring to the accompanying drawings.

### BRIEF DESCRIPTION OF THE DRAWINGS

The following figures are part of the present specification, included to demonstrate certain aspects of various embodiments of this disclosure and referenced in the detailed description herein:

FIG. 1 represents a horizontal view of an exemplary screen assembly for use in the disclosed method.

FIG. 2 illustrates a horizontal view of an exemplary open hole gravel pack operation using multipath screen assemblies 10.

FIGS. 3A and 3B illustrate a horizontal three-dimensional depiction of the formation of an annular sand bridges in an open hole gravel pack operation using a well treatment fluid containing ULW particulates. FIG. 3A depicts the use of the screen assemblies in the methods of the prior art wherein a slurry containing particulates in excess of 2.65 are pumped into the well. FIG. 3B shows that the treatment fluids defined herein can easily extend past the annular bridge and exit through exit ports 18 of the screen assembly.

### DETAILED DESCRIPTION OF THE PREFERRED EMBODIMENTS

Characteristics and advantages of the present disclosure and additional features and benefits will be readily apparent to those skilled in the art upon consideration of the following detailed description of exemplary embodiments and referring to the accompanying figures. It should be understood that the description herein and appended drawings, being of example embodiments, are not intended to limit the claims of this patent or any patent or patent application claiming priority hereto. On the contrary, the intention is to cover all modifications, equivalents and alternatives falling within the spirit and scope of the claims. Many changes may be made to the particular embodiments and details disclosed herein without departing from such spirit and scope.

As used herein and throughout various portions (and headings) of this patent application, the terms “disclosure”, “present disclosure” and variations thereof are not intended to mean every possible embodiment encompassed by this disclosure or any particular claim(s). Thus, the subject matter of each such reference should not be considered as necessary for, or part of, every embodiment hereof or of any particular claim(s) merely because of such reference.

As used herein, the terms “including” and “comprising” are used herein and in the appended claims in an open-ended fashion, and thus should be interpreted to mean “including, but not limited to . . . .” Further, reference herein and in the appended claims to components and aspects in a singular tense does not necessarily limit the present disclosure or appended claims to only one such component or aspect, but should be interpreted generally to mean one or more, as may be suitable and desirable in each particular instance.

The efficiency of gravel packing operations using alternate path or multi-path screens is improved by the use of ultra lightweight (ULW) particulates. The alternate path or multi-path screens are defined by the screen assembly having a screen and one or more transport tubes having one or more exit ports.

By “ultra lightweight” it is meant that the particulate has an ASG less than or equal to 2.45, preferably less than or equal to 2.25, more preferably less than or equal to 2.0, even more preferably less than or equal to 1.75. In some embodiment, the ASG is less than or equal to 1.25 and often less than or equal to 1.10. The use of ULW particulates in multi-path screen gravel packing operations enables pumping of the well treatment fluid containing the particulates into the well and screen assemblies at a reduced rate (compared to slurries containing conventional particulates). In addition, the use of ULW particulates in multi-path screen gravel pack operations reduces friction pressures in the workstring across the formation. The generation of bridges and incomplete gravel packs is thereby minimized.

The method disclosed herein has particular applicability in the treatment of horizontal wells though it is equally applicable to the treatment of vertical wells and deviated wells. The method may be used in the treatment of oil wells, gas wells, geothermal wells, etc.

Further, the disclosure relates to the use of ULW particulates in open hole gravel pack applications as well as in those gravel pack applications wherein casing has been placed within the wellbore. In open hole gravel applications, an annulus is formed within the well between the screen assembly and the subterranean formation. Where the well is equipped with a casing, the casing is bonded to the walls of the well by a cement sheath and perforation tunnels which extend through the casing and the cement sheath provides fluid communication between the intervals of the well and the formation.

The ULW particulate is preferably substantially neutrally buoyant in the carrier fluid. The term “substantially neutrally buoyant” refers to the condition wherein the particulate has a density sufficiently close to the density of the carrier fluid (generally no greater than about 20%, typically no greater than 15%, higher than the density of the carrier fluid) which allows pumping and satisfactory placement of the particulate into the formation. In substantially neutrally buoyant fluids, the ULW particulate basically floats within the carrier fluid. Such fluids are more easy to pump and can be easily re-suspended even when settling.

The ULW particulates are preferably used without a gel carrier, thereby avoiding the drawbacks associated with viscous carrier fluids. In addition, since gels are not required, the fluid does not require breaker additives. This eliminates the need for specialized blending and pumping equipment. Further, packing density is increased and long term packing efficiency is improved by use of the substantially neutral buoyant ULW particulate in the carrier fluid because the gravel pack does not have to be broken once packing operations are complete. Gels typically used to help keep conventional particulates suspended can cause up to 15% after-pack settling when the breaker is applied. By use of the well treatment fluids defined herein, initial packing efficiency is improved and the screen of the screen assembly stays protected. Further, potentially damaging polymer residues are eliminated, reducing the risk of near-wellbore damage and negative effects on production.

Additionally, particular to flow of solids laden fluid through multi-path devices (i.e. through narrow diameter but very long in length), transport of ULW particulates in a carrier fluid of water has been found to be very efficient, meaning the movement of water through narrow tubes and the mass transfer of the ULW particulates in the water being pumped through the narrow tubes (i.e. slurry) is surprisingly easy compared to viscous gravel pack gel containing conventional sand or ceramic gravel particulates. In other words, the movement of the water/ULW particles slurry requires less pressure, the ULW particulates do not lag during slurry movement, and the mass transfer of gravel solids is ideal for multi-path transport tube for long distance placement in horizontal wellbores compared to viscous slurries with conventional heavy particulates movement within narrow but extremely long horizontal transport tubes. The improved mass transfer requires less pump pressure and thus may allow higher pump rates (i.e. reduce the treatment time, a cost savings for offshore rigs rig-time cost). In addition, it provides the capability of allowing longer length multi-path screen tools to be used compared to gelled slurry packs. Gelled slurry packs mass transfer in small diameter but long transport tubes typically limits the length of the multi-path screen gravel pack tools to between 3,000 to 4,000 feet horizontal or inclined length. In contrast, in the disclosed method, it is possible to increase the multi-path screen tool length to 6,000 to 7,000 feet or more through the improved mass transport efficiency the water carrier fluid with ULW particulates exhibits. This represents a huge increase in the amount of increased wellbore area within the reservoir, allowing for increases in total reservoir hydrocarbon flow and additional wellbore area which can over time incur formation damage without the same proportional reduction in hydrocarbon production as compared to smaller length multi-path screen tool use. The longer length wellbore (and multi-path screen tool) also may lower the reservoir hydrocarbon production flow pressure (production pressure per foot of wellbore length) for equivalent hydrocarbon production rates compared to shorter multi-path screen tool lengths. This should further reduce “fines migration” due to high reservoir fluids flow rates.

Any carrier fluid suitable for transporting the ULW particulate may be employed including, but not limited to, carrier fluids comprising completion brines, fresh water and liquid hydrocarbons. The carrier fluid is preferably ungelled.

The selection of the completion brine is dependent on reservoir characteristics. For instance, high density brines (such as sodium chloride, potassium chloride, calcium chloride, sodium bromide, calcium bromide, zinc bromide, potassium formate, cesium formate and sodium formate brines) have been found to have particular applicability in deep wells, such as those that descend 15,000 to 30,000 feet (4,500 to 10,000 meters). High density brines are further needed in those situations where gravel packing must be conducted at high temperatures in order to withstand high fluid pressures downhole.

The composition of the brine determines the fluid properties of the well treatment fluid and thus the selection of the ULW particulate. Such fluid properties may include, for example, pH, density, etc. Being substantially neutrally buoyant, the ULW particulate is selected based on the density of the carrier fluid. For instance, where the fluid has an ASG of about 1.25, selected ULW particulates may have an ASG of about 1.2. By selecting a particulate having a density that closely matches the density of the carrier fluid, proppant transport becomes extremely efficient with lower requirements on the carrier fluid and an expanded engineering envelop to perform horizontal gravel pack operations at lower pumping rates and/or over longer distances.

In an embodiment, friction pressures are reduced (compared to conventional carrier gels) by using a small quantity of friction reducing agents. Such agents allow the fluids to be pumped at higher rates (i.e., shorter operation) as well as over longer distances (thereby enabling completion of longer wells using multi-path screens than that seen with viscous fluids containing conventional particulates or particulates having an ASG in excess of 2.45. Surface pressure is reduced since the friction pressure is reduced. This in turn minimizes fluid leakoff to the formation. In an embodiment, the fluid may further contain between from about 0 pounds to about 4 pounds per thousand gallons of friction reducer per thousand gallons of base fluid.

The most common friction reducers are polyacrylamide (PAM) polymers. Various copolymers have also been developed to further enhance the performance of polyacrylamide friction reducer. Sodium acrylamido-2-methylpropane sulfonate (sodium AMPS) and acrylic acid are often common monomers besides the acrylamide in these copolymers. Friction reducers may further include those set forth in Canadian Patent No. 2,641,479, herein incorporated by reference.

ULW particulates for use in the disclosure include porous particulates and/or deformable particulates. By “deformable” it is meant that the particulates of the gravel pack substantially yield upon application of a minimum threshold level to point to point stress.

The ULW particulates range in size from 6 to 100 mesh, preferably 20/40 to 40/60 mesh.

Suitable relatively lightweight solid particulates are those disclosed in U.S. Pat. Nos. 6,364,018; 6,330,916; and 6,059,034, all of which are herein incorporated by reference. Exemplary of suitable ULW particulates include shells of nuts such as walnut, pecan, coconut, almond, ivory nut, brazil nut, etc.; seed shells of fruits such as plum, olive, peach, cherry, apricot, and the like; seed shells of other plants such as maize (e.g., corn cobs or corn kernels); wood materials such as those derived from oak, hickory, walnut, poplar, mahogany, and the like.

Further examples of suitable ULW particulates include polystyrene divinylbenzene, copolymers and terpolymers (such as polystyrene/vinyl/divinyl benzene and acrylate-based terpolymers), and polymers of furfuryl derivatives, phenol formaldehyde, phenolic epoxy resins, polystyrene, methyl methacrylate, nylon, polycarbonates, polyethylene, polypropylene, polyvinylchloride, polyacrylonitrile-butadiene-styrene, polyurethane and mixtures thereof. Further, such copolymers may be reacted with a crosslinker, such as divinyl benzene. Other solid particulates for use herein include nylon, polystyrene and polyethylene terephthalate.

The ULW particulates for use in the disclosure may be coated particulates as well as non-coated particulates. Suitable coatings may include a resin including cured, partially cured, or uncured coatings of a thermoset or thermoplastic resin. For instance, the coating of the solid particulate may be an organic compound that includes epoxy, phenolic, polyurethane, polycarbodiimide, polyamide, polyamide imide, furan resins, or a combination thereof.

Preferred relatively lightweight particulates include polyamides, such as those disclosed in U.S. Pat. No. 7,931,087, herein incorporated by reference as well as porous particulates include porous particulates such as porous ceramics treated with a non-porous penetrating coating and/or glazing material. Such materials are disclosed in U.S. Pat. No. 7,426,961, herein incorporated by reference and include those composites wherein (a) the ASG of the treated porous material is less than the ASG of the porous particulate material; (b) the permeability of the treated material is less than the permeability of the porous particulate material; or (c) the porosity of the treated material is less than the porosity of the porous particulate material.

Also included within exemplary particulates are well treating aggregates composed of an organic lightweight material and a weight modifying agent. The ASG of the organic lightweight material is either greater than or less than the ASG of the well treating aggregate depending on if the weight modifying agent is a weighting agent or weight reducing agent, respectively. The aggregates may be comprised of a continuous (external) phase composed of the organic lightweight material and a discontinuous (internal) phase composed of a weight modifying material. Such aggregates include those disclosed in U.S. Pat. No. 7,772,163, herein incorporated by reference.

Further, a mixture of any of the referenced particulates may be utilized.

The ULW particulates may be formed by crushing, grinding, cutting, chipping, and the like or otherwise processed. Typically, the particle size of the particulates employed in may range from about 4 mesh to about 100 mesh.

The ULW particulates may be defined by any shape. For instance, the ULW particulates may be spherical or non-spherical such as an elongated, tapered, egg, tear drop or oval shape or mixtures thereof. For instance, the ULW particulates may have a shape that is cubic, bar-shaped (as in a hexahedron with a length greater than its width, and a width greater than its thickness), cylindrical, multi-faceted, irregular, beaded or mixtures thereof. In addition, the ULW particulates may have a surface that is substantially roughened or irregular in nature or a surface that is substantially smooth in nature. Moreover, mixtures or blends of ULW particulates having differing, but suitable, shapes for use in the disclosed method further are employed.

In an embodiment, the amount of sand control particulate in the fluid may be between from about 0.2 to 10 pounds of ULW particulates per gallon of fluid composition, but higher or lower concentrations can be used as required. When the composition contains a low density brine, the amount of ULW particulates is typically lower. For instance, where the ULW particulates have an ASG of about 1.1, the amount of ULW particulates required is about 1.7 pounds per gallon of carrier fluid. In contrast, where the ULW particulates are heavier materials, such as a porous ceramic, the amount of ULW particulates required is about 4 pounds per gallon of carrier fluid. Thus, while the same volume of fluid composition may be pumped into the well, the concentration of ULW particulates in the fluid composition is dependent on the ASG of the ULW particulates.

The methods described herein may be used in the treatment of conventional rock formations such as carbonate formations and sand formations and in particular unconsolidated or poorly consolidated sand formations. The methods described herein are especially effective with highly permeability subterranean reservoirs, such as those having a permeability from about 100 to about 8,000 mD.

The fluid containing the ULW particulates is easily delivered to the screen and directly distributed to different levels within the internal alternate flowpath of the screen and throughout the completion interval.

In operation, the gravel pack packer is set inside the casing and isolates the portion of the openhole well (or casing). The screen is located inside the openhole well (or inside the casing containing the perforation tunnels). The screen is supported by the gravel pack packer.

In operation, the screen assembly is lowered on a workstring down to the production formation within the wellbore. The well treatment fluid comprising the ULW particulates in carrier is then pumped down the workstring and out into the well annulus surrounding the screen via a cross-over tool connected to cross-over ports below the gravel pack packer.

As the fluid flows into the well annulus (or casing), it also flows through the inlet in the upper end of the annulus and into the transport tubes of the screen assembly (i.e. annulus being adjacent to the non-perforated sections of one or more concentric pipes). In those instances where a sand bridge forms in the well annulus before all of the gravel has been placed in the annulus, the fluid is able to flow through one or more of the transport tubes and exits through one or more of the exit ports into the different levels of the well annulus to finish gravel packing the completion interval. Once the gravel pack is complete, the cross-over, etc., is removed and the well is put on production. Fluids, produced from the formation, flow through the gravel pack and then to the surface through a tubing string connected to the gravel pack packer.

Multi-path screen assemblies are reported in the literature and may be used in the method disclosed herein. For instance, the screen assembly may contain a series of transport tubes placed externally on the outer surface of the screen. The sand screen may be those conventionally employed and may include wire wrapped screens, slotted liner, pre-pack screens or premium mesh screens. The purpose of the sand screen is to allow fluid flow from the formation while preventing the movement of sand and gravel through the screen. The transport tubes have exit ports along their lengths. The screen generally corresponds to one joint of pipe, typically 40 feet or less. Such screen assemblies are disclosed in U.S. Pat. Nos. 4,945,991; 5,082,052; 5,113,935; 5,417,284; and 5,419,394, herein incorporated by reference.

The apertures on the screen are of a size sufficient for the fluid containing the ULW particulates to be forced into the annulus of the well and out the perforation tunnels into the formation. Typically, the apertures on the screen are between from about 0.1 mm to about 5 mm, more typically from about 0.15 to about 0.5 mm.

The transport tubes mounted or incorporated into the screen are in juxtaposition with the exterior of the screen. The transport tubes are of sufficient size to permit the flow of the treatment fluid containing the ULW particulates. The transport tubes extend substantially throughout the distance of the annular space of the well to be gravel packed and can be open at both ends or open at the top and sealed at its lower end. The transport tubes are in communication with a plurality of exit ports on one or more screen joints establish fluid communication between the transport tubes and the annulus. The exit ports are sufficient in number and size to permit the flow of the well treatment fluid containing the ULW particulates from the transport tubes to the annulus.

The transport tubes may also be located internally within the screen. Such screen assemblies are disclosed in U.S. Pat. Nos. 5,341,880; 5,476,143; and 5,515,915, herein incorporated by reference. An outer pipe may further be concentrically positioned over the transport tubes whereby an annulus is formed between the transport tubes and the outer pipe. In this arrangement, both the transport tubes and the outer pipe may have exit ports along their respective lengths but only through a radial portion of their respective circumferences. This provides each pipe with a respective perforated, radial section and a non-perforated, radial section which, in turn, radially align, respectively, when the pipes are concentrically positioned. Such screen assemblies are disclosed in U.S. Pat. Nos. 6,227,303 and 6,220,345, herein incorporated by reference.

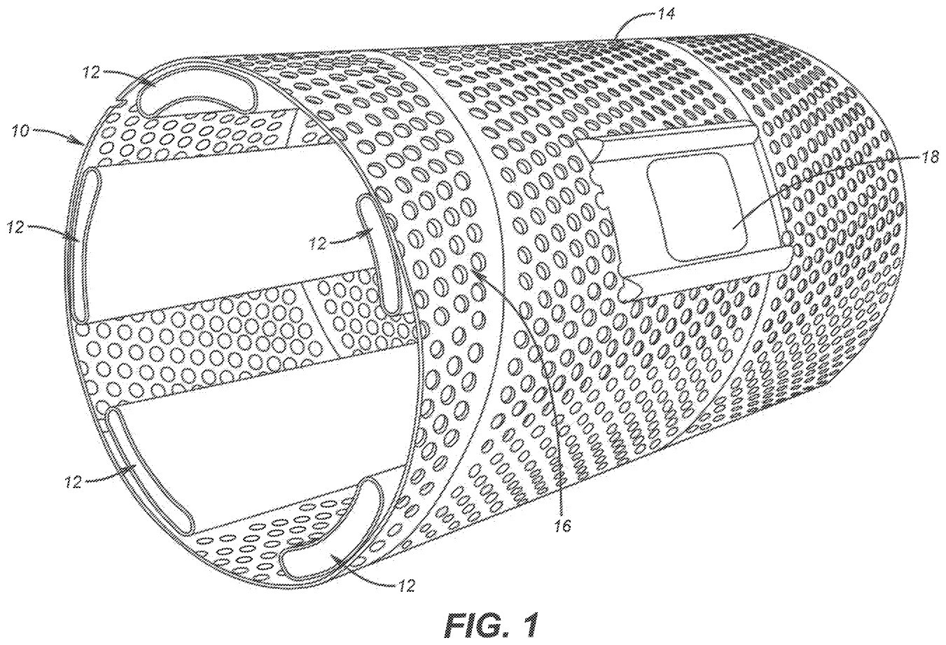

FIG. 1 illustrates an exemplary screen assembly 10 which comprises a series of transport tubes 12 internally situated within screen 14. Transport tubes are illustrated as being of kidney shape to maximize the flow area at minimal diameter. The transport tubes and screen are housed in packing tube 16. FIG. 1 illustrates multitude transport tubes within the screen which maximizes the flow area at reduced friction. The treatment fluid containing the ULW particulates is able to pass through exit port 18 of the screen assembly into the well annulus.

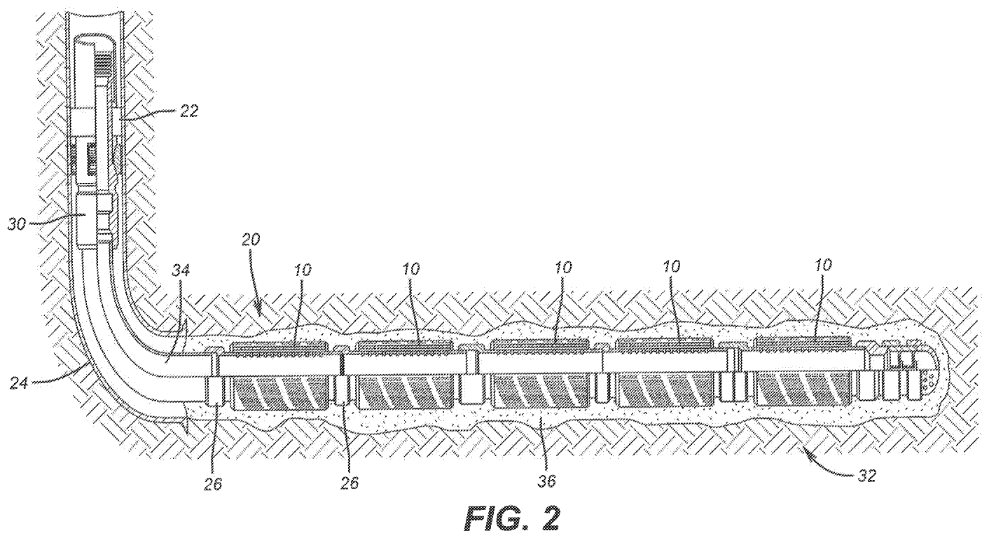

FIG. 2 illustrates an open hole gravel pack operation wherein multiple multipath screen assemblies 10 are placed into horizontal wellbore 20 separated by connector joints 26. While wellbore 20 is illustrated as being substantially horizontal, the wellbore could be vertical or deviated as well. The screen assembly is shown as being held into place within the wellbore by packer 22 around base pipe 34. Base pipe 34 is lowered into horizontal wellbore 20 at heel 24 on a workstring (not shown). Transport tubes 12 may be perforated for the well treatment fluid to flow into screen 14. In order to circulate the ULW particulates around the screen, a crossover 28 is used on the workstring. It connects to gravel pack extension 30. The well treatment fluid is then pumped down the workstring into toe 32 of the well around screen assembly 10. The well treatment fluid containing the ULW particulates flows through the screen assembly and exits through one or more of the exit ports 18. The ULW particulates form a gravel pack around the annulus of the well. Hydrocarbons produced from the formation flow through the permeable gravel pack and into the well; the permeable gravel pack controlling the flow of sand from the formation.

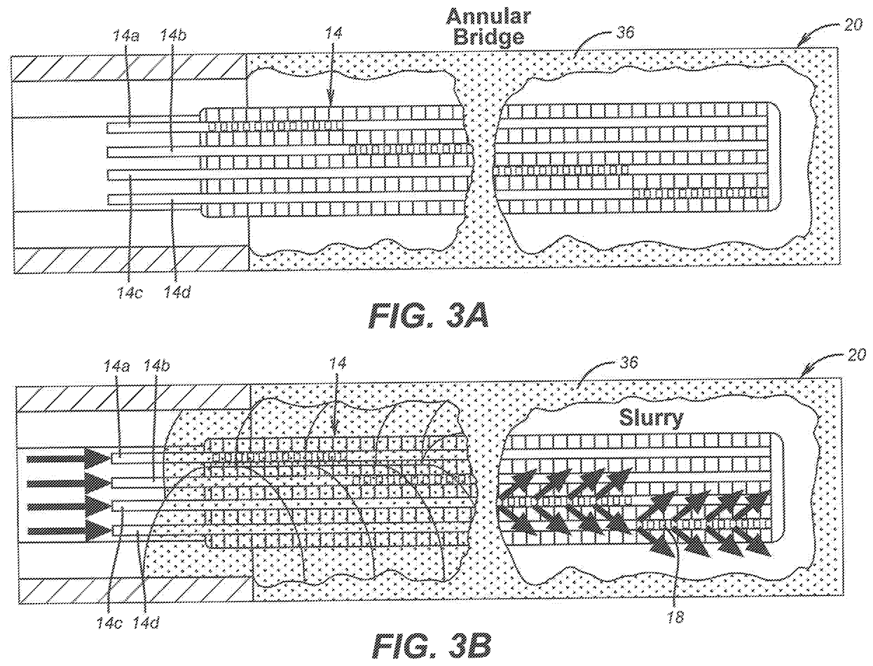

In many locations, clays are highly reactive, formations are soft and unstable and can be easily fractured since they are relatively shallow in deepwater. As a result, the wellbore can collapse, clay can swell into the wellbore or fluid can be lost to the formation leaving a bridge of gravel in the wellbore that prevents further gravel to be circulated. FIG. 3 illustrates the formation of an annular sand bridge which blocks further flow through screens 14. The screen assemblies 14a, 14b, 14c and 14d provide multiple flow paths for the gravel slurry to be circulated, even beyond obstruction in the annulus. As such, particulates may be placed farther away from the wellbore.

FIG. 3(A) depicts the use of the screen assemblies in the methods of the prior art wherein a slurry containing particulates in excess of 2.65 are pumped into the well. Each screen assembly is designed for flow of the slurry out of the transport tube at a defined location. Tube 14a is shown as being placed within the first quarter of horizontal well 20. Tube 14b is shown as being placed having within the second quarter of horizontal well 20. Tube 14c is shown as being placed in the third quarter of horizontal well 20 and past the annular sand bridge. Tube 14d is shown as being placed in the last quarter of horizontal well 20 and farther past the annular sand bridge. When pumping slurries containing conventional particulates (having an ASG in excess of 2.65), the slurry is unable to be extended past the annular bridge because the heavier particulates are excessively packed within the first and second quarters of the horizontal well. This is illustrated in FIG. 3B (prior to the prior art slurry reaching the annular bridge). In such instances, it is relatively unnecessary for the screen assemblies to contain transport tubes because most of the slurry can exit through the screen. FIG. 3B shows that the treatment fluids defined herein can easily extend past the annular bridge and exit through exit ports 18 of the screen assembly. As such, the use of the treatment fluid containing ULW particulates is able to extend a sufficient gravel pack past annular obstructions.

Thus, the distribution of the ULW particulates to the various levels in formation 36 from the multiport screen assembly 10 provides a better distribution of gravel through the entire completion interval especially when said bridges form in the annulus before all of the gravel has been placed. In addition, the use of ULW particulates in the well treatment fluid reduces friction pressures in the transport tubes and there is no need for the well treatment fluid to be viscous or require the presence of a viscosifying agent. Formation damage is therefore minimized.

Preferred embodiments of the present disclosure thus offer advantages over the prior art and are well adapted to carry out one or more of the objects of this disclosure. However, the present disclosure does not require each of the components and acts described above and are in no way limited to the above-described embodiments or methods of operation. Any one or more of the above components, features and processes may be employed in any suitable configuration without inclusion of other such components, features and processes. Moreover, the present disclosure includes additional features, capabilities, functions, methods, uses and applications that have not been specifically addressed herein but are, or will become, apparent from the description herein, the appended drawings and claims.

### EXAMPLES

A 400 ft. yard test was conducted LiteProp 108 (an ULW particulate having an ASG of about 1.08, available from Baker Hughes Incorporated) which was substantially neutrally buoyant in fresh water. The testing demonstrated excellent packing and particulate flow through multi-path transport tubes across obstructions and thief zones compared to a viscous gel containing Carbolite®, available from Carbo Ceramics and having a specific gravity of 2.65. The concentration of particulates in each of the tested fluids was about 0.05 ft³ per gallon. The screen assembly was the EXCELLPAK™ multi-path screen, a product of Baker Hughes Incorporated. The screen assembly consisted of four kidney-shaped transport tubes (each having a screen diameter of about 1 square inch) to increase flow area and provide redundant slurry channels. The well treatment fluid was pumped down through the tubes, allowed to commingle and was then redistributed at each coupling. The well treatment particulate then exited the screen through the multiple ports located along the length of each screen joint. The results demonstrate that a treatment fluid containing LiteProp 108 is more efficient than the viscous gel containing Carbolite®. The ULW particulate maintained suspension during the process and friction was reduced.

In the field, once the latter traveled past 4,000 feet, the amount of pressure required to transport the fluid further is too high. This could cause tool failure as well as formation damage. The amount of distance that the well treatment fluids defined herein containing the ULW particulates can travel can be as high as 8,000 feet. Thus, treatment fluids containing ULW particulates can extend the formation of the gravel pack in greater depths (vertical wells) or lengths (horizontal wells) than treatment fluids containing conventional particulates (having an ASG greater than or equal to about 2.65. This renders greater productivity of production fluid from the well while limiting the amount of damage to the reservoir over time. Further, the data demonstrates that nominal friction pressures (psi/ft per barrel/min) of the well treatment fluids containing substantially neutrally buoyant ULW particulates is ⅓ the amount evidenced with the viscous gel containing Carbolite®. Further, greater concentrations of ULW particulates can be pumped through the screen without settling or sedimentation.

TABLE I

| Fluid | Carbolite | Brine w/1 gptg Friction Reducer |
|---|---|---|
| Particulate | 20/40 Gravel | LiteProp 108 |
| Particulate ASG | 2.65 | 1.06 |
| Loading of Particulate | 5.5 ppg | 1.63 (4 ppg equivalent) |
| Rate (bpm) | 6 | 6 |
| Interval Length (ft) | 400 | 200 |
| Obstructions | Thief Zone + Annular Barrier | Annular Barrier |
| Sustained Pump Pressure (psi) | 600 | 130 |
| Friction Pressure per bpm (psi/ft) | 0.30 | 0.11 |
| Packing Efficiency | 99% | 96% |

The methods that may be claimed herein and any other methods which may fall within the scope of the appended claims do not necessarily require use of the particular embodiments shown and described herein. While exemplary embodiments of the disclosure have been shown and described, variations, modifications and/or changes to the methods are possible within the scope of the appended claims, and may be made and used by one of ordinary skill in the art without departing from the spirit or teachings of the disclosure and scope of appended claims. Thus, all matter herein set forth or shown in the accompanying drawings should be interpreted as illustrative, and the scope of the disclosure and the appended claims should not be limited to the embodiments described and shown herein.

What is claimed is:

1. A method for gravel packing a well penetrating a sand formation, the method comprising:
(a) positioning inside the well a screen assembly comprising a screen and one or more transport tubes wherein the one or more transport tubes extend along the length of the screen and further wherein each of the one or more transport tubes have one or more exit ports;
(b) pumping a well treatment fluid into the well, wherein the well treatment fluid comprises a carrier fluid and ultra lightweight particulates having an ASG less than or equal to 2.45;
(c) flowing the well treatment fluid through one or more exit ports in one or more of the transport tubes; and
(d) forming a gravel pack comprising the ULW particulates onto the screen of the screen assembly.

2. A method of completing a well penetrating a subterranean formation by horizontal open hole gravel packing comprising:
(a) positioning a sand screen assembly inside the well and forming an annulus between the sand screen assembly and the subterranean formation, wherein the sand screen assembly comprises a screen and one or more transport tubes extending down the length of the screen wherein each of the one or more transport tubes has one or more exit ports;
(b) pumping a well treatment fluid comprising a carrier and ultra lightweight particulates having an apparent specific gravity (ASG) less than or equal to 2.45 into the well and flowing the carrier through one or more of the exit ports in the one or more transport tubes; and
(c) forming a gravel pack from the ULW particulates onto the screen of the sand screen assembly.

3. A method of gravel packing a well penetrating a subterranean formation comprising:
(a) positioning inside the well a series of connecting screen assemblies, wherein each screen assembly comprises one or more transport tubes and a screen, wherein the one or more transport tubes have one or more exit ports;
(b) pumping a well treatment fluid comprising a carrier fluid and ultra lightweight particulates having an ASG less than or equal to 2.45 into the well and into the screen assemblies, wherein the ultra lightweight particulates are substantially neutrally buoyant in the carrier; and
(c) forming a gravel pack from the ULW particulates onto the screen assemblies.

4. A method of gravel packing an open hole well penetrating a subterranean formation comprising:
(a) positioning a screen assembly inside the open hole well, wherein the screen assembly comprises a screen and at least one transport tube having one or more exit ports;
(b) pumping a well treatment fluid into the well and through one or more of the exit ports, wherein the well treatment fluid comprises a carrier fluid, a friction reducer and ultra lightweight particulates having an ASG less than or equal to 2.45 and further wherein the ultra lightweight particulates are substantially neutrally buoyant in the carrier fluid; and
(c) forming a gravel pack from the ULW particulates onto the screen of the screen assembly.

5. A method of gravel packing an open hole well penetrating a subterranean formation comprising:
(a) positioning a screen assembly inside the open hole well, wherein the screen assembly comprises a screen and at least one transport tube inside of the screen wherein the at least one transport tube has one or more exit ports;
(b) pumping a well treatment fluid into the well, wherein the well treatment fluid comprises a carrier and ultra lightweight particulates having an apparent specific gravity less than or equal to 2.45, wherein the ultra lightweight particulates are substantially neutrally buoyant in the carrier fluid; and
(c) flowing the carrier through the one or more exit ports of at least transport tube and forming a gravel pack from the ULW particulates onto the screen of the screen assembly.

6. A method of gravel packing a well penetrating a subterranean formation comprising:
(a) positioning a casing with well;
(b) perforating the well through the casing;
(c) positioning a screen assembly inside the well between the casing and the annulus of the well, wherein the screen assembly comprises a screen and at least one transport tube having one or more exit ports;
(d) pumping a well treatment fluid into the well and through the screen assembly, wherein the well treatment fluid comprises a carrier fluid and ultra lightweight particulates having an ASG less than or equal to 2.45, wherein the ultra lightweight particulates are substantially neutrally buoyant in the carrier fluid; and
(e) flowing the well treatment fluid through at least one of the exit ports on at last one of the transport tube sand forming a gravel pack from the ULW particulates onto the screen of the screen assembly.

7. The method of any of claims 1 to 6, wherein the well is a horizontal well.

8. The method of any of claims 1 to 6, wherein the well is a deviated well.

9. The method of any of claims 1 to 6, wherein the well is a vertical well.

10. The method of any of claims 1 to 7, wherein the well is an oil well.

11. The method of any of claims 1 to 7, wherein the well is a gas well.

12. The method of any of claims 1 to 7, wherein the well is a geothermal well.

13. The method of any of claims 1 to 12, wherein the screen assembly is placed into the well after a casing is placed in the well.

14. The method of any of claims 1 to 13, wherein the well is an open hole well.

15. The method of any of claims 1 to 14, wherein the ultra lightweight particulate has an ASG less than or equal to 2.25.

16. The method of claim 15, wherein the ultra lightweight particulate has an ASG less than or equal to 2.0.

17. The method of claim 16, wherein the ultra lightweight particulate has an ASG less than or equal to 1.75.

18. The method of claim 17, wherein the ultra lightweight particulate has an ASG less than or equal to 1.5.

19. The material of claim 18, wherein the ultra lightweight particulate has an ASG less than or equal to 1.25.

20. The method of any of claims 1 to 19, wherein the ultra lightweight particulate is substantially neutrally buoyant in a carrier fluid.

21. The method of claims 1 to 20, wherein the carrier fluid is selected from the group consisting of fresh water or completion brines.

22. The method of any of claims 1 to 21, wherein the well treatment fluid further comprises a friction reducer.

23. The method of claim 22, wherein the friction reducer is a polyacrylamide.

24. The method of claim 22, wherein the friction reducer is a copolymer of sodium acrylamido-2-methylpropane sulfonate.

25. The method of any of claims 1 to 24, wherein the ultra lightweight particulate has a protective or hardened coating.

26. The method of any of claims 1 to 25, wherein the ultra lightweight particulate is a furan, furfuryl, phenol formaldehyde, phenolic epoxy, melamine formaldehyde resin, urethane resin or a mixture thereof.

27. The method of any of claims 1 to 25, wherein the ultra lightweight particulate deformable particulate is polystyrene divinylbenzene, polystyrene/vinyl/divinyl benzene, acrylate-based terpolymer or a mixture thereof.

28. The method of any of claims 1 to 25, wherein the ultra lightweight particulate is a natural product selected from chipped, ground or crushed nut shells, seed shells, fruit pits and processed wood at least partially coated or hardened with a protective coating or modifying agent.

29. The method of claim 28, wherein the natural product is selected from chipped, ground or crushed (i.) walnut, pecan, coconut, almond, ivory or brazil nuts; (ii.) peach, plum, olive, cherry, or apricot seed shells.

30. The method of claim 28, wherein the natural product is derived from oak, hickory, walnut, polar or mahogany.

31. The method of any of claims 1 to 25, wherein the ultra lightweight particulate is a polyamide, polystyrene, polyethylene terephthalate or polycarbonate or a mixture thereof.

32. The method of any of claims 1 to 25, wherein the ultra lightweight particulate is beaded, cubic, cylindrical, bar-shaped, multi-faceted, irregular or tapered in shape.

33. The method of any of claims 1 to 32, wherein the permeability of the subterranean formation is from about 100 to about 8,000 mD.

34. The method of any of claims 1 to 32, wherein the subterranean formation is sandstone.
